(19) United States
(12) Patent Application Publication
(10) Pub. No.: US 2016/0023372 A1
(43) Pub. Date: Jan. 28, 2016

(54) MORTISING TOOL

(71) Applicant: Techtronic Industries Co. Ltd., Tsuen Wan (HK)

(72) Inventors: Richard M. Davidian, Pickens, SC (US); Nicholas Costanzo, Greenville, SC (US)

(21) Appl. No.: 14/338,822

(22) Filed: Jul. 23, 2014

(51) Int. Cl. B27F 5/00; B25D 3/00; B27G 17/00

(52) U.S. Cl. CPC B27F 5/00; B27G 17/00; B25D 3/00

(57) ABSTRACT

A mortising tool or mortiser including a handle having a first longitudinal axis and a head having a second longitudinal axis. The mortiser includes an interchangeable scorer holder that has a first side and a second side. A first scorer is fixedly attached to the first side, and a second scorer different from the first scorer is fixedly attached to the second side. The interchangeable scorer holder is positionable in a first orientation substantially within a chamber to expose the first scorer and positionable in a second orientation substantially within the chamber to expose the second scorer. A guide is received by the mortiser and orients one of the first scorer and the second scorer at a desired distance from a face of a door. The guide is positionable in two orientations to orient one of the scorers at either a first or second distance from the face of the door.

### BACKGROUND

The present invention relates to a mortising tool, and more particularly to a door latch mortiser including an interchangeable scorer holder.

The installation of a door in a door frame often requires the formation of a mortise. The mortise allows for the recessed placement of the mortise plate in the formed mortise.

### SUMMARY

The invention provides, in one aspect, a mortiser for installing a mortise in an edge of a door having a face including a handle having a first longitudinal axis and a head having a second longitudinal axis. The head is formed with the handle as a single piece and defines a chamber. An interchangeable scorer holder having a first side and a second side is positioned at least partially within the chamber in one of a first orientation and a second orientation. A first scorer is fixedly attached to the first side and extends outward from the chamber when the interchangeable scorer holder is positioned in the first orientation, and a second scorer different from the first scorer is fixedly attached to the second side. The second scorer extends outward from the chamber when the interchangeable scorer holder is positioned in the second orientation. A guide is coupled to the head and spaced apart from the chamber. The guide is arranged to abut the face of the door to position the one of the first scorer and the second scorer that is exposed at a desired distance from the face of the door.

The invention provides, in another aspect, a mortiser for installing a mortise in an edge of a door having a face including a T-shaped member having a handle portion and a head portion formed with the handle portion as a single piece. A surface is formed as part of the head portion and is substantially planar. A perimeter wall extends inward from the surface to at least partially define a chamber, and a slot wall is formed in the T-shaped member to at least partially define a slot. A scorer is positioned at least partially within the chamber and extends beyond the surface. An L-shaped guide includes a main plate arranged to abut the face of the door and an attachment flange arranged to be received within the slot. The main plate is positioned a first distance from the chamber when the attachment flange is positioned within the slot in a first orientation, and the main plate is positioned a second distance from the chamber different from the first distance when the attachment flange is positioned within the slot in a second orientation.

Other features and aspects of the invention will become apparent by consideration of the following detailed description and accompanying drawings.

### BRIEF DESCRIPTION OF THE DRAWINGS

FIG. 1 is a perspective view of a mortiser embodying the present invention.

FIG. 2 is an exploded perspective view of the mortiser of FIG. 1.

FIG. 3 is another exploded perspective view of the mortiser of FIG. 1.

FIG. 4 is another perspective view of the mortiser of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

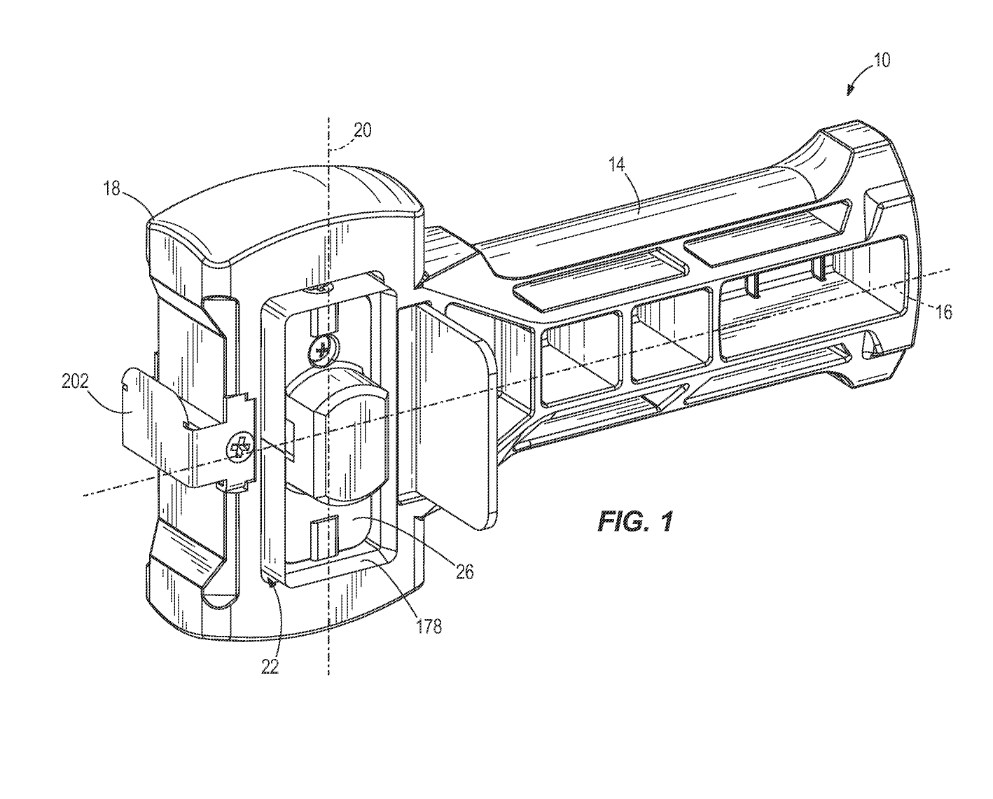

FIGS. 1-4 illustrate a mortising tool or mortiser 10 suitable for use with a door lock locator used to complete a door lock installation. Of course, the mortiser 10 may be used by itself to create a mortise. As shown in FIG. 1, the mortiser 10 is preferably T-shaped and includes a handle 14 that has a first longitudinal axis 16 and a head 18 that has a second longitudinal axis 20 normal to the first longitudinal axis 16. The head 18 of the mortiser 10 defines a chamber 22 that releasably secures an interchangeable scorer holder 26 positioned within the chamber 22.

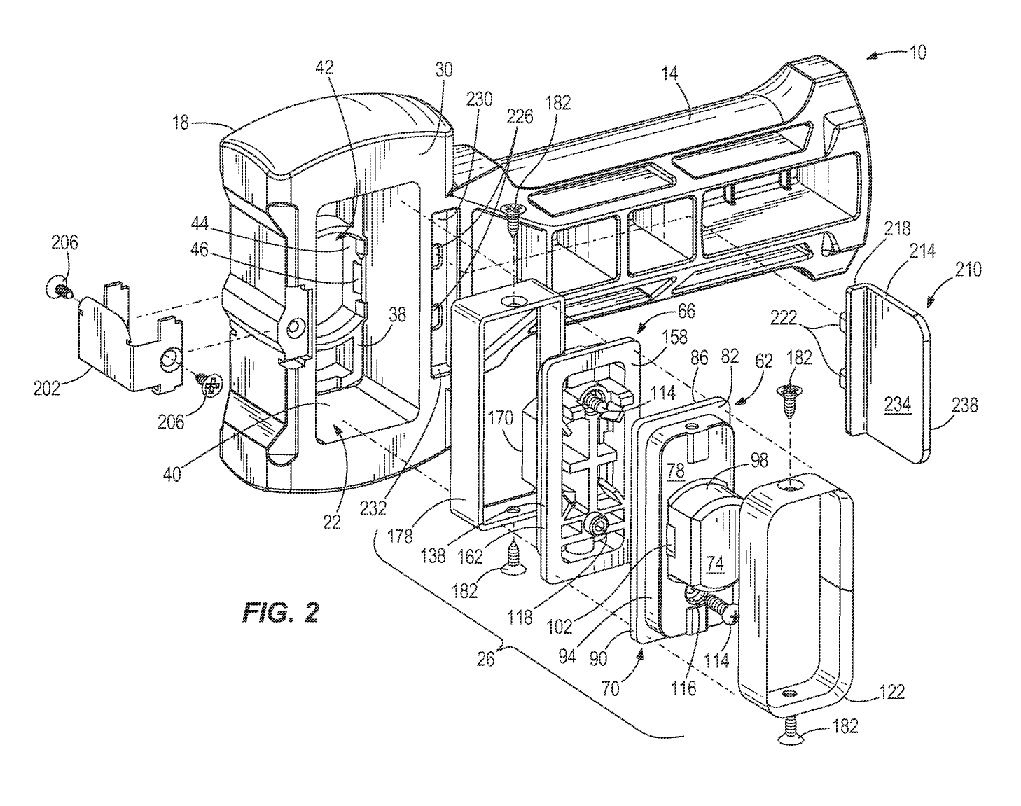

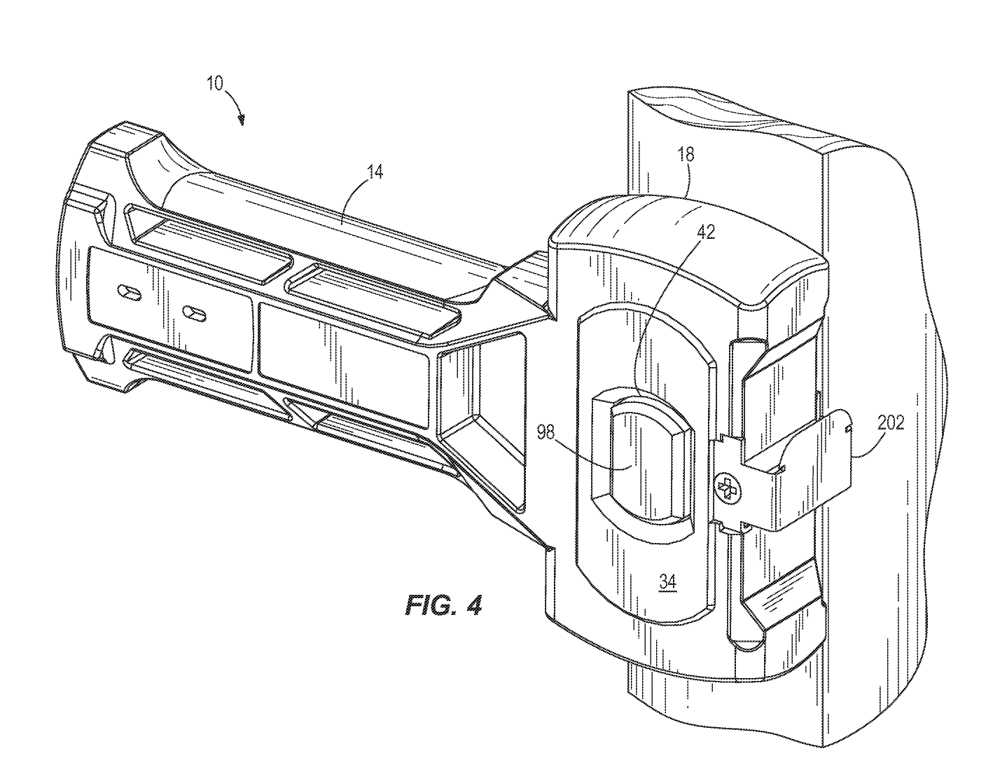

As shown in FIG. 2, the mortiser 10 includes an outer surface 30, an opposing outer surface 34 (shown in FIG. 4), and an interior surface 38 that are substantially parallel to one another. The head 18 includes a substantially rectangular first perimeter wall 40 that extends from the outer surface 30 to the interior surface 38 and at least partially defines the chamber 22. The head 18 further includes a second perimeter wall 44 that extends from the interior surface 38 to the opposing outer surface 34 and that at least partially defines an aperture 42. The cross-sectional area of the aperture 42 is less than the cross-sectional area of the chamber 22. A tab 46 is positioned on the second perimeter wall 44 adjacent to the chamber 22. In some embodiments, the tab 46 is integrated into the perimeter wall 58.

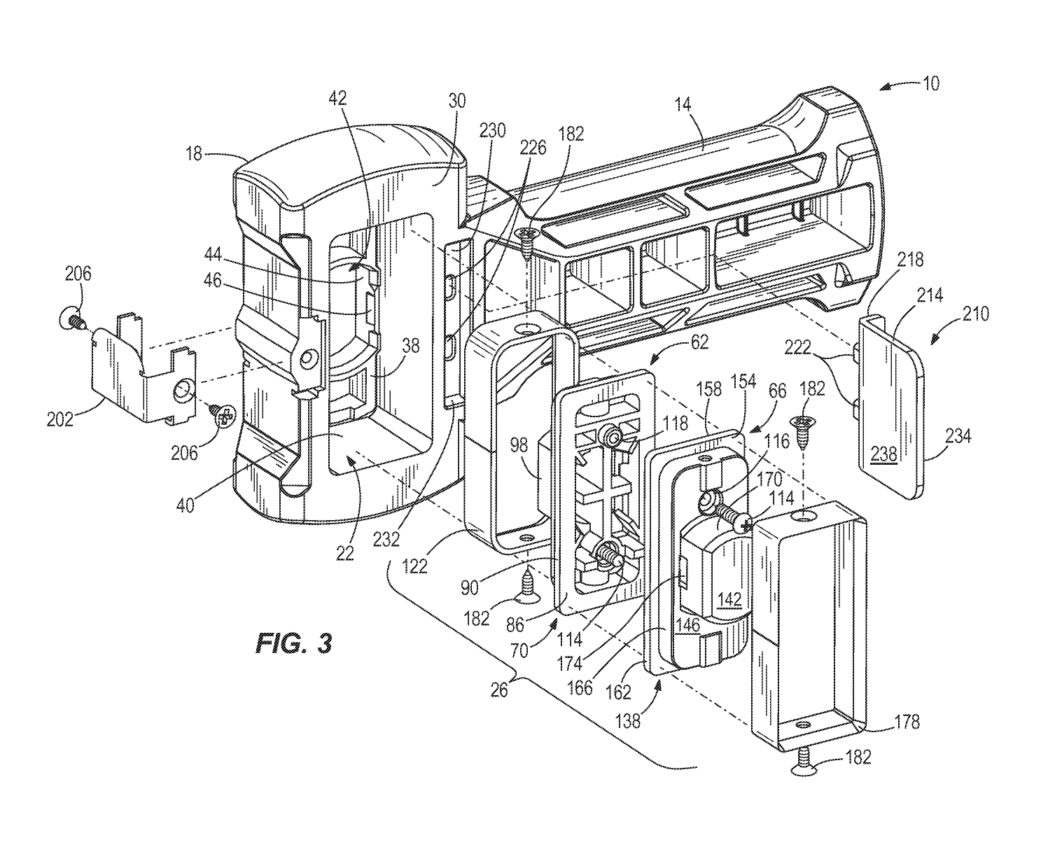

With continued reference to FIG. 2, the interchangeable scorer holder 26 includes a first side 62 and a second side 66. Each side 62, 66 of the interchangeable scorer holder 26 holds a respective scorer 122, 178. The first side 62 has a body 70 including a guide post surface 74, a front surface 78, an intermediate surface 82, and a rear surface 86 that are substantially parallel to one another. A base 90 extends between the rear surface 86 and the intermediate surface 82. A platform 94 extends between the intermediate surface 82 and the front surface 78. A guide post 98 extends between the front surface 78 and the guide post surface 74. The guide post 98 includes a recess 102 for engaging the tab 46. The cross-sectional area of the base 90 is greater than the cross-sectional area of the platform 94 and the cross-sectional area of the platform 94 is greater than the cross-sectional area of the guide post 98. As shown in FIG. 3, a screw 114 passes through an opening 116 and engages a corresponding threaded opening 118 that is positioned on the rear surface 86 to secure the first side 62 to the second side 66. A scorer 122 surrounds the perimeter of the platform 94 and extends past the front surface 78, but not past the guide post surface 74. The distance between the top of the scorer 122 and the front surface 78 is equal to or greater than the depth of a desired mortise plate. In some embodiments, a tab and latch are used to secure the first side 62 to the second side 66 in place of the screw 114.

Turning to FIG. 3, the second side 66 has a body 138 including a guide post surface 142, a front surface 146, an intermediate surface 154, and a rear surface 158 that are substantially parallel to one another. A base 162 extends between the rear surface 158 and the intermediate surface 154. A platform 166 extends between the intermediate surface 154 and the front surface 146. A guide post 170 extends between the front surface 146 and the guide post surface 142. The guide post 170 includes a recess 174 for engaging the tab 46. The cross-sectional area of the base 162 is greater than the cross-sectional area of the platform 166, and the cross-sectional area of the platform 166 is greater than the cross-sectional area of the guide post 170. A scorer 178 surrounds the perimeter of the platform 166 and extends past the front surface 146, but not past the guide post surface 142. As shown in FIG. 2, a screw 114 passes through an opening 116 and engages with a corresponding threaded opening 118 that is positioned on the rear surface 158 to secure the first side 62 to the second side 66. The distance between the top of the scorer 178 and the front surface 146 is equal to or greater than the depth of a desired mortise plate.

The second scorer 178 is different than the first scorer 122. In one construction, the first scorer 122 is a round corner scorer and the second scorer 178 is a square corner scorer, with other shaped scorers and other variations being possible. Each scorer 122, 178 is attached to the respective side by a pair of screws 182. The sides 62, 66 are preferably made of plastic and the scorers 122, 178 are preferably made of metal. In other embodiments, the sides 62, 66 and the scorers 122, 178 are made of other suitable materials.

The interchangeable scorer holder 26 can be positioned within the chamber 22 in two orientations. In either orientation, the scorer holder 26 is substantially within the chamber 22. As shown in FIG. 2, in the first orientation, the first scorer 122 is exposed such that at least a portion of the first scorer 122 and the first guide post 98 extend out of the chamber 22 and past the outer surface 30 of the head 18. The second guide post 170 is received by the aperture 42. The aperture 42 and the guide post 170 have similar perimeter shapes. The scorer holder 26 is releasably secured in the chamber 22 by the tab 46. The tab 46 engages the recess 174, thereby securing the scorer holder 26 in the chamber 22. The scorer holder 26 can be released and removed from the chamber 22 by applying a force to the second guide post 170 through the aperture 42, thereby overcoming the holding force of the tab 46.

As shown in FIG. 3, in the second orientation, the second scorer 178 is exposed such that at least a portion of the second scorer 178 and the second guide post 170 extend out of the chamber 22 and past the outer surface 30 of the head 18. The first guide post 98 is received by the aperture 42. The aperture 42 and the guide post 98 have similar perimeter shapes. The scorer holder 26 is secured and released in a similar fashion as it is in the first orientation. The scorer holder 26 is releasably secured in the chamber 22 by the tab 46. The tab 46 engages the recess 102, thereby securing the scorer holder 26 in the chamber 22. The scorer holder 26 can be released and removed from the chamber 22 by applying a force to the first guide post 98 through the aperture 42 (FIG. 4), thereby overcoming the holding force of the tab 46.

As shown in FIG. 2, the mortiser 10 also includes a chisel 202 that is attached to the head 18 of the mortiser 10. The chisel 202 is fixedly attached to the head 18 by a pair of screws 206. Of course, more than one chisel 202 could be attached to the head 18 or handle 14 if desired and other attachment mechanisms could be employed.

The mortiser 10 also includes an L-shaped guide 210 that includes a main plate 214 and an attachment flange 218. Two engagement prongs 222 extend from a surface of the attachment flange 218 and are arranged to connect the guide 210 to the head 18. The attachment flange 218 is received in a slot 230 at least partially defined by a slot wall 232 formed in the mortiser 10, and the two prongs 222 are snugly received in corresponding recesses 226 defined by the head 18 within the slot 230 to hold the guide 210 in place. The main plate 214 of the guide 210 has a first abutment surface 234 that is arranged to engage an edge or face of the door or component on which the mortiser 10 is being used while the guide 210 is in a first orientation (FIG. 2). The guide 210 also has a second abutment surface 238 that is arranged to engage the edge or face of the door while the guide 210 is in a second orientation (FIG. 3) that is 180 degrees from the first orientation. The guide 210 attaches to the head 18 in a first orientation to space the main plate 214 from the chamber 22 a first desired distance and attaches to the head 18 in a second orientation to space the main plate 214 from the chamber 22 a second desired distance different from the desired distance. The first and second distances are selected so that the scorer is properly positioned for either of two common door thicknesses. Thus, the guide 210 is positioned in the first orientation for a first door thickness (FIG. 2) and the guide 210 is positioned in the second orientation for a second door thickness (FIG. 3).

In use, the user determines which orientation of the interchangeable scorer holder 26 and the L-shaped guide 210 is appropriate for the mortise plate to be used. The mortiser 10 is used in the same manner regardless of the orientation of the scorer holder 26 and the L-shaped guide 210. The first orientations of the scorer holder 26 and the L-shaped guide 210 will be used for purposes of description. The user first places the guide post 98 into a pre-drilled edge hole until the scorer 122 comes into contact with the outer surface of the latch edge. The abutment surface 234 of the guide 210 is placed against a face of a door and helps set the proper orientation of the scorer 122. More specifically, the guide 210 positions the scorer 122 at a first desired distance away from the corresponding face of the door. After the scorer 122 is properly aligned or positioned, the user holds the handle 14 and then applies a force to the opposing outer surface 34 until the front surface 78 is flush with the latch edge of the door. The scorer 122 is thereby driven into the latch edge to a depth equal to or slightly greater than the depth of the mortise plate, creating a mortise-score. The force can be applied using a hammer or any other striking tool. The user then removes the scorer 122 from the latch edge. The mortise-score defines the mortise to be removed from the latch edge. The user then uses the chisel 202 to remove the material inside the mortise-score. After the material inside the mortise-score has been removed, the mortise is formed and the user can install the mortise plate.

Various features of the invention are set forth in the following claims.

What is claimed is:

1. A mortiser for installing a mortise in an edge of a door having a face, the mortiser comprising:
a handle having a first longitudinal axis;
a head having a second longitudinal axis and formed with the handle as a single piece, the head defining a chamber;
an interchangeable scorer holder having a first side and a second side, the interchangeable scorer holder positioned at least partially within the chamber in one of a first orientation and a second orientation;
a first scorer fixedly attached to the first side and extending outward from the chamber when the interchangeable scorer holder is positioned in the first orientation;
a second scorer different from the first scorer and fixedly attached to the second side, the second scorer extending outward from the chamber when the interchangeable scorer holder is positioned in the second orientation; and
a guide coupled to the head and spaced apart from the chamber, the guide arranged to abut the face of the door to position the one of the first scorer and the second scorer that is exposed at a desired distance from the face of the door.

2. The mortiser of claim 1, wherein the first longitudinal axis is normal to the second longitudinal axis.

3. The mortiser of claim 1, further comprising a chisel fixedly attached to the head of the mortiser.

4. The mortiser of claim 1, wherein the first scorer includes a round corner and the second scorer includes a square corner.

5. The mortiser of claim 1, further comprising a tab positioned adjacent to the chamber, the tab engageable with a corresponding recess on the interchangeable scorer holder to releasably secure the interchangeable scorer holder at least partially within the chamber.

6. The mortiser of claim 1, wherein the head further comprises a perimeter wall extending between an outer surface and an inner surface, the perimeter wall and the inner surface at least partially defining the chamber.

7. The mortiser of claim 6, wherein the perimeter wall is a first perimeter wall and the outer surface is a first outer surface, the mortiser further comprising a second perimeter wall extending between the inner surface and a second outer surface opposite the first outer surface, the second perimeter wall at least partially defining an aperture.

8. The mortiser of claim 1, further comprising a first guide post formed with the first side of the interchangeable scorer holder as a single piece and a second guide post formed with the second side of the interchangeable scorer holder as a single piece.

9. The mortiser of claim 1, wherein the guide includes a main plate arranged to abut the door face, an attachment flange coupled to the main plate and substantially normal to the main plate, and an engagement prong arranged to connect the guide to the head.

10. The mortiser of claim 9, wherein the attachment flange is received within a slot at least partially defined by the head.

11. The mortiser of claim 9, wherein the desired distance is a first desired distance, and wherein the guide attaches to the head in a first orientation to space the main plate from the chamber the first desired distance and attaches to the head in a second orientation to space the main plate from the chamber a second desired distance, which is different from the first desired distance.

12. A mortiser for installing a mortise in an edge of a door having a face, the mortiser comprising:
a T-shaped member including a handle portion and a head portion formed with the handle portion as a single piece;
a surface formed as part of the head portion and being substantially planar;
a perimeter wall extending inward from the surface to at least partially define a chamber;
a slot wall formed in the T-shaped member to at least partially define a slot;
a scorer positioned at least partially within the chamber and extending beyond the surface; and
an L-shaped guide including a main plate arranged to abut the face of the door and an attachment flange arranged to be received within the slot, wherein the main plate is positioned a first distance from the chamber when the attachment flange is positioned within the slot in a first orientation and the main plate is positioned a second distance from the chamber different from the first distance when the attachment flange is positioned within the slot in a second orientation.

13. The mortiser of claim 12, wherein the second orientation is 180 degrees from the first orientation.

14. The mortiser of claim 12, wherein the scorer is a first scorer, the mortiser further comprising:
an interchangeable scorer holder having a first side and a second side, the interchangeable scorer holder positioned at least partially within the chamber in one of a first orientation and a second orientation;
the first scorer fixedly attached to the first side and extending outward from the chamber when the interchangeable scorer holder is positioned in the first orientation; and
a second scorer different from the scorer and fixedly attached to the second side, the second scorer extending outward from the chamber when the interchangeable scorer holder is positioned in the second orientation.

15. The mortiser of claim 14, wherein the first scorer includes a round corner and the second scorer includes a square corner.

16. The mortiser of claim 14, further comprising a tab positioned adjacent to the chamber, the tab engageable with a corresponding recess on the interchangeable scorer holder to releasably secure the interchangeable scorer holder at least partially within the chamber.

17. The mortiser of claim 14, further comprising a first guide post formed with the first side of the interchangeable scorer holder as a single piece and a second guide post formed with the second side of the interchangeable scorer holder as a single piece.

18. The mortiser of claim 12, wherein the guide includes an engagement prong arranged to connect the guide to the head portion.

19. The mortiser of claim 12, wherein the perimeter wall is a first perimeter wall and the surface is a first outer surface, the mortiser further comprising a second perimeter wall extending between an inner surface and a second outer surface opposite the first outer surface, the second perimeter wall at least partially defining an aperture.

20. The mortiser of claim 12, further comprising a chisel fixedly attached to the head portion of the mortiser.
